(19) United States
(12) Patent Application Publication
(10) Pub. No.: US 2020/0064583 A1
(43) Pub. Date: Feb. 27, 2020

(54) CAMERA

(71) Applicant: TRIPLE WIN TECHNOLOGY(SHENZHEN) CO.LTD., Shenzhen (CN)

(72) Inventors: SHENG-JIE DING, Shenzhen (CN); SHIN-WEN CHEN, Tu-Cheng (TW); JING-WEI LI, Shenzhen (CN); JIAN-CHAO SONG, Shenzhen (CN)

(21) Appl. No.: 16/182,560

(22) Filed: Nov. 6, 2018

(30) Foreign Application Priority Data
Aug. 24, 2018 (CN) 201821379835.2

(51) Int. Cl. G02B 7/02; G03B 11/00; G02B 7/00; H04N 5/225

(52) U.S. Cl. CPC G02B 7/022; G03B 11/00; H04N 5/2253; G02B 7/025; G02B 7/006

(57) ABSTRACT

A camera includes a bracket, a lens, a filter, a circuit board, a lens base, and a photosensitive chip. The bracket defines a through hole. The lens is mounted on the bracket. The is filter mounted on a side of the bracket and covers the through hole. The circuit board is mounted on a side of the bracket opposite to the filter. The lens base is mounted on the side of the bracket mounted to the filter. The photosensitive chip is mounted on the circuit board and faces the through hole. One of the bracket and the lens base includes a number of positioning members. The other one of the bracket and the lens base defines a number of positioning holes. Each positioning member is received in a corresponding one of the positioning holes.

### FIELD

The subject matter herein generally relates to cameras.

### BACKGROUND

Cameras are often mounted in electronic devices, such as mobile phones and tablet computers. If the electronic device is accidentally dropped, the camera is easy to be damaged.

### BRIEF DESCRIPTION OF THE DRAWINGS

Implementations of the present disclosure will now be described, by way of example only, with reference to the attached figures.

FIG. 1 is an assembled, isometric view of an embodiment of a camera.

FIG. 2 is an exploded, isometric view of the camera in FIG. 1.

FIG. 3 is similar to FIG. 2, but shows the camera from another angle.

FIG. 4 is a cross-sectional view taken along line IV-IV in FIG. 1.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

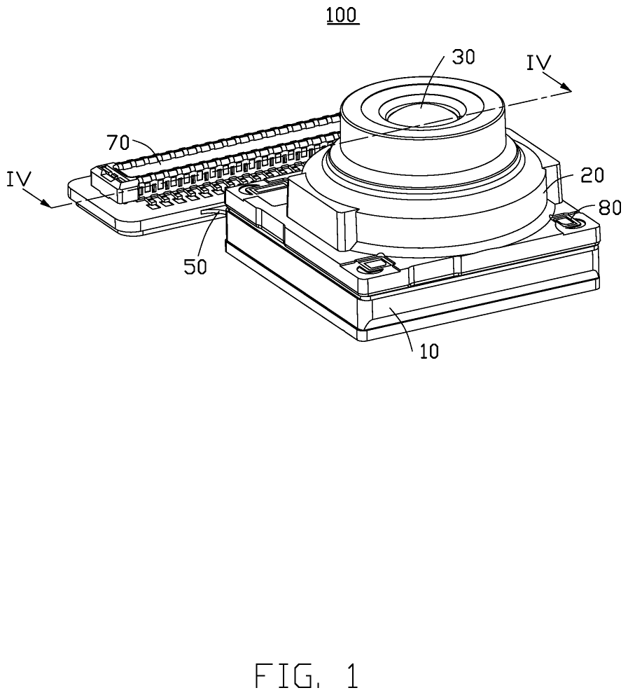

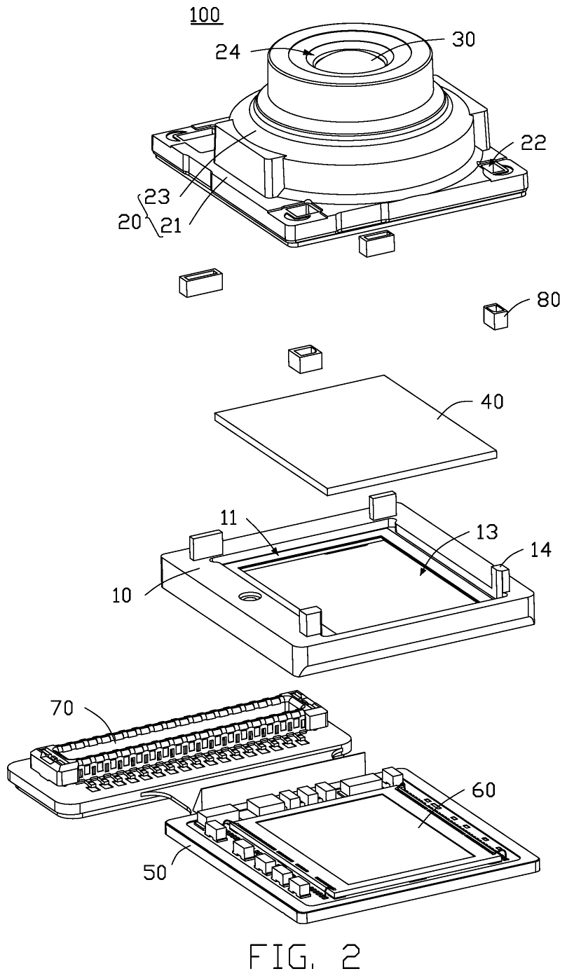

FIG. 1 and FIG. 2 show an embodiment of a camera 100. The camera 100 includes a bracket 10, a lens base 20, a lens 30, a filter 40, a circuit board 50, a photosensitive chip 60, and a connector 70. The lens base 20, the filter 40, the circuit board 50, and the photosensitive chip 60 are mounted on the bracket 10. The lens 30 is mounted on the lens base 20. The connector 70 is electrically coupled to the circuit board 50.

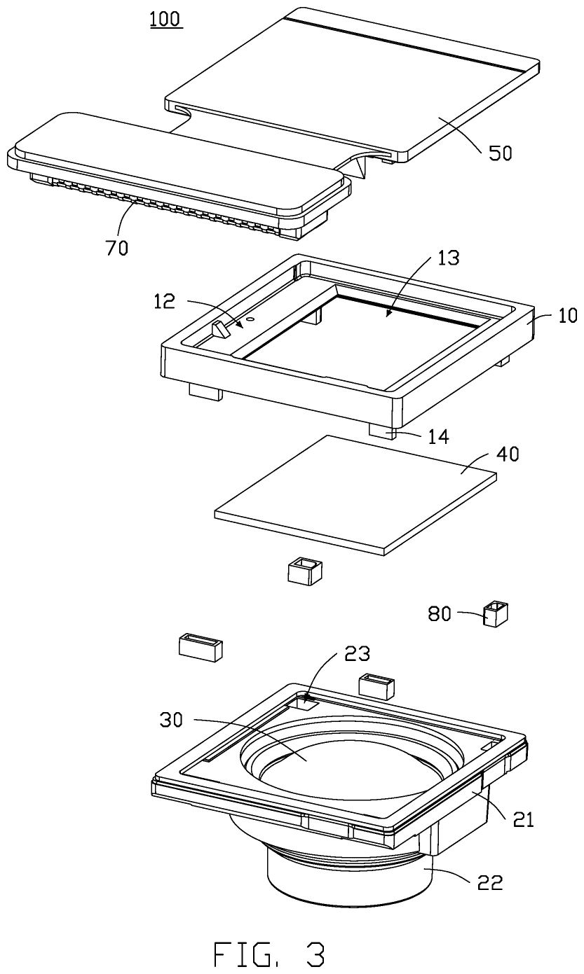

FIG. 2 and FIG. 3 show the frame 10 is substantially rectangular. The frame 10 defines a first receiving space 11, a second receiving space 12, and a through hole 13. The first receiving space 11 and the second receiving space 12 are defined in opposite surfaces of the bracket 10. The through hole 13 is in communication with the first receiving space 11 and the second receiving space 12. The through hole 13 is substantially rectangular, but is not limited to be rectangular. In other embodiments, the through hole 13 may be other shapes according to requirements.

The bracket 10 includes a plurality of positioning member 14. The positioning members 14 are mounted on the surface of the bracket 10 defining the first receiving hole 11. The positioning members 14 are equally spaced apart around the first positioning hole 11. In one embodiment, a quantity of the positioning members 14 is four. Each positioning member 14 is substantially prism columnar, but is not limited to be prism columnar. In other embodiments, the positioning members 14 may be other shapes according to requirements.

The lens base 20 is mounted on the side of the bracket 10 defining the first receiving space 11. The lens base 20 includes a base body 21 and a step portion 22. The lens body 21 is substantially perpendicular. The lens body 21 defines a plurality of positioning holes 23. The positioning holes 23 are equally spaced apart around the step portion 22. Each positioning hole 23 receives a corresponding one of the positioning members 14. The step portion 22 protrudes from a central portion of a surface of the base body 21. The step portion 22 defines a mounting hole 24. The mounting hole 24 is defined in an end surface of the step portion 21 and extends through the base body 21. The lens 30 is partially mounted within the mounting hole 24. It should be understood that the step portion 22 includes therein a voice coil motor and other components for operating the lens 30. In one embodiment, each positioning hole 23 is substantially rectangular, but is not limited to be rectangular. In other embodiments, the positioning holes 23 may be other shapes.

The filter 40 is receiving within the first receiving space 11 and covers the through hole 13. In one embodiment, the filter 40 is substantially rectangular, but is not limited to be rectangular. In other embodiments, the filter 40 may be other shapes according to requirements.

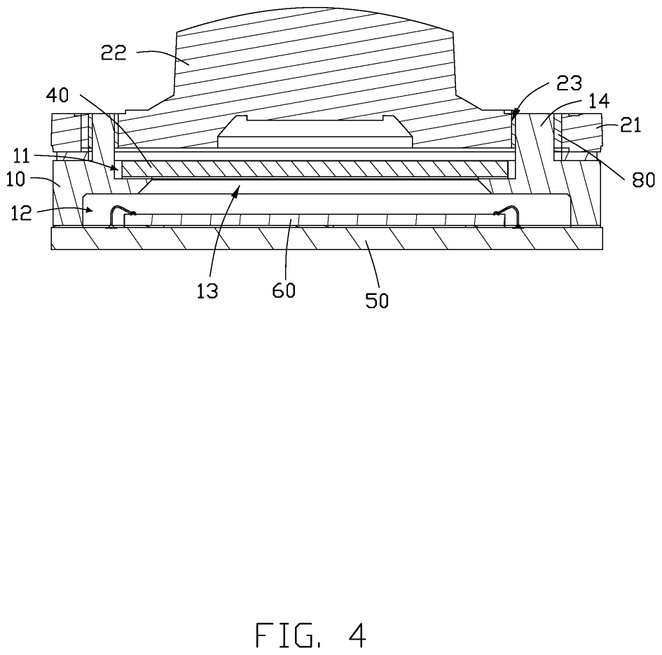

FIG. 1 and FIG. 4 show the circuit board 50 mounted on the side of the bracket 10 defining the second receiving space 12. The photosensitive chip 60 is mounted on and electrically coupled to the circuit board 50. The photosensitive chip 60 is received within the second receiving space 12 and faces the through hole 13. The connector 70 is mounted on and electrically coupled to the circuit board 50. The connector 70 is configured to provide power and transmit information to the lens 100. In one embodiment, the circuit board 100 is a flexible circuit board.

The camera 100 further includes a plurality of bonding members 80. Each bonding member 80 is sleeved over a corresponding one of the positioning members 14 and receiving within the corresponding positioning hole 23 to secure the positioning members 14 within the positioning holes 23. In one embodiment, the bonding members 80 are formed by an adhesive filled in between the positioning members 14 and a wall of the positioning holes 23 and then cured.

In assembly, the filter 40 is received within the first receiving hole 11 to cover the through hole 13. The lens base 20 is mounted on the side of the bracket 10 defining the first receiving hole 11. The positioning members 14 are received within the corresponding positioning holes 23. The adhesive is filled in between the positioning members 14 and the wall of the positioning holes 23 and then cured to form the bonding members 80. The lens 30 is partially mounted within the mounting hole 24 of the lens base 20. The photosensitive chip 60 is mounted on the circuit board 50. The circuit board 50 is mounted on the side of the bracket 10 defining the second receiving space 12. The connector 70 is mounted on and electrically coupled to the circuit board 50 to complete assembly of the camera 100.

In other embodiments, the connector 70 may be omitted, such that the circuit board 50 is electrically coupled directly to the external component.

In other embodiments, the first receiving space 11 and the second receiving space 12 may be omitted, such that the filter 40 and the photosensitive chip 60 are directly mounted on either side of the bracket 10.

In other embodiments, the bracket 10 may define the plurality of positioning holes 23, and the base body 21 of the lens base 20 may include the plurality of positioning members 14.

In other embodiments, a shape of each of the positioning members 14 may be different, and a shape of each of the positioning holes 23 is different and corresponding to the shape of the corresponding positioning member 14.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A camera comprising:
a bracket defining a through hole;
a lens mounted on the bracket;
a filter mounted on a side of the bracket and covering the through hole;
a circuit board mounted on a side of the bracket opposite to the filter;
a lens base mounted on the side of the bracket mounted to the filter; and
a photosensitive chip mounted on the circuit board and facing the through hole; wherein:
one of the bracket and the lens base comprises a plurality of positioning members;
the other one of the bracket and the lens base defines a plurality of positioning holes; and
each positioning member is received in a corresponding one of the positioning holes.

2. The camera of claim 1, wherein:
the bracket defines a first receiving space and a second receiving space;
the first receiving space and the second receiving space are defined in opposite sides of the bracket;
the through hole is in communication with the first receiving space and the second receiving space;
the filter is received within the first receiving space; and
the photosensitive chip is received within the second receiving space.

3. The camera of claim 2, wherein:
the lens base comprises a base body and a step portion;
the step portion protrudes from a central portion of a surface of the lens base;
the step portion defines a mounting hole in an end surface of the step portion and extending through the step portion and the base body; and
the lens is partially mounted within the mounting hole.

4. The camera of claim 3, wherein:
the plurality of positioning members are mounted on the side of the bracket defining the first receiving space;
the plurality of positioning members are equally spaced apart around the first receiving space;
the plurality of positioning holes are defined through the base body and equally spaced apart around the base body.

5. The camera of claim 4, wherein each positioning member is prism columnar, and every positioning hole is rectangular.

6. The camera of claim 4, wherein a shape of each positioning member is different, and a shape of every positioning hole corresponds in shape to the corresponding positioning member.

7. The camera of claim 1, further comprising a plurality of bonding members; each of the plurality of bonding members is sleeved over a corresponding one of the positioning members and received in the corresponding positioning hole.

8. The camera of claim 7, wherein the plurality of bonding members are formed by curing an adhesive filled in between the positioning members and a wall of the positioning holes.

9. The camera of claim 1, further comprising a connector mounted on the circuit board and electrically coupled to the circuit board; the connector is configured to electrically couple to an external component to provide power and transmit information to the camera.
